(19) United States
(12) Patent Application Publication
(10) Pub. No.: US 2026/0004664 A1
(43) Pub. Date: Jan. 1, 2026

(54) ROUTE GENERATION METHOD, ROUTE GENERATION DEVICE, AND STORAGE MEDIUM

(71) Applicant: ARASHI VISION INC., Shenzhen (CN)

(72) Inventor: Xuan XI, Shenzhen (CN)

(73) Assignee: ARASHI VISION INC., Shenzhen (CN)

(21) Appl. No.: 19/243,744

(22) Filed: Jun. 20, 2025

(30) Foreign Application Priority Data
Jun. 28, 2024 (CN) 202410870091.8

(51) Int. Cl. G08G 5/34; G06F 3/04847; G08G 5/20; G08G 5/57

(52) U.S. Cl. CPC G08G 5/34; G06F 3/04847; G08G 5/20; G08G 5/57; G06F 2203/04806

(57) ABSTRACT

A route generation device may include at least one processor and at least one memory. The at least one memory may store a computer program. The at least one processor, when executing the computer program, may be configured to in response to an operation on a route template, display the route template on a display interface displaying a map after the operation, wherein the route template includes a route trajectory corresponding to one or more route segments; determine a route starting point corresponding to the route template on the map; and determine a flight route of a movable platform according to the route starting point and the route template.

### CROSS-REFERENCE TO RELATED APPLICATION

The present application claims priority to Chinese Patent Application No. 202410870091.8, filed Jun. 28, 2024, the entire content of which being incorporated herein by reference in its entirety.

### TECHNICAL OF FIELD

The present application relates to but is not limited to a field of control technology, and in particular to a route generation method, a route generation device and a storage medium.

### BACKGROUND

The current route generation method of a movable platform is usually based on a method of marking points on a map. Specifically, multiple Global Positioning System (GPS) coordinate points are selected on the map, and then the selected coordinate points are connected to form a route. However, this method of generating routes by manually marking points one by one has low operating efficiency.

### SUMMARY

In one embodiment, a route generation method may include, in response to an operation on a route template, displaying the route template on a display interface displaying a map after the operation, the route template including a route trajectory corresponding to one or more route segments; determining a route starting point corresponding to the route template on the map; and determining a flight route of a movable platform according to the route starting point and the route template.

In another embodiment, the present application provides a route generation device. The route generation device comprises at least one processor and at least one memory, the at least one memory stores a computer program; the at least one processor, when executing the computer program, is configured to, in response to an operation on a route template, display the route template on a display interface displaying a map after the operation, wherein the route template includes a route trajectory corresponding to one or more route segments; determine a route starting point corresponding to the route template on the map; and determine a flight route of a movable platform according to the route starting point and the route template.

In another embodiment, the present application provides a system. The system comprises a movable platform; and the route generation device according to one embodiment of the present disclosure.

Through the route generation method provided by one embodiment of the present application, after selecting a route template, the route starting point of the route template is determined on the map, and the route template can be bound to the map coordinates to obtain an executable flight route, thereby realizing rapid generation of the route, and solving the problem of low operating efficiency in the related art of manually generating routes one by one.

### BRIEF DESCRIPTION OF THE DRAWINGS

In order to more clearly illustrate the technical solutions in the embodiments of the present disclosure, the accompanying drawings to be used in the embodiments will be briefly introduced below, and it will be obvious that the accompanying drawings in the following description are only some of the embodiments of the present disclosure, and that for the person of ordinary skill in the field, other accompanying drawings can be obtained based on these drawings, without giving creative labor.

FIG. 1 is a first flow chart of a route generation method according to an embodiment of the present application;

FIG. 2 is a second flow chart of a route generation method according to an embodiment of the present application;

FIG. 3 is a side view of adjusting a zoom ratio when performing a zoom operation according to an embodiment of the present application;

FIG. 4 is a third flow chart of a route generation method according to an embodiment of the present application;

FIG. 5 is a fourth flow chart of a route generation method according to an embodiment of the present application;

FIG. 6 is a fifth flowchart chart of a route generation method according to an embodiment of the present application;

FIG. 7 is a sixth flow chart of a route generation method according to an embodiment of the present application;

FIG. 8 is a schematic structural diagram of a route generation device according to an embodiment of the present application.

### DETAILED DESCRIPTION

In order to make the purpose, technical solution and advantages of the present application more clearly understood, some embodiments of the present application are further described in detail below in conjunction with accompanying drawings and embodiments. It should be understood that the specific embodiments described herein are only used to explain the present application and are not used to limit the present application.

In order to make the purpose, technical scheme and advantages of the embodiments of the present application clearer, the specific technical scheme of the present application will be further described in detail below in conjunction with the drawings in the embodiments of the present application. The following embodiments are used to illustrate the present application, but are not used to limit the scope of the present application.

Unless otherwise defined, all technical and scientific terms used herein have the same meaning as those commonly understood by those skilled in the art to which this application belongs. The terms used herein are only for the purpose of describing the embodiments of this application and are not intended to limit this application.

In the following description, reference is made to “some embodiments”, which describe a subset of all possible embodiments, but it will be understood that “some embodiments” may be the same subset or different subsets of all possible embodiments and may be combined with each other if without conflict.

It should be pointed out that the terms “first\second\third” involved in the embodiments of the present application are merely to distinguish similar objects and do not represent a specific ordering of the objects. It can be understood that “first\second\third” can be interchanged in a specific order or sequence where permitted, so that the embodiments of the present application described here can be implemented in an order other than that illustrated or described here.

One embodiment of the present application provides a route generation method. In actual application, a hardware terminal implementing the route generation method can be a controller, which can be set in a movable platform, a control device of the movable platform, or a server/Alternatively, one of the movable platform, the control device of the movable platform, or the server is selected to include a part of the controller, and the other part of the controller is disposed in one of the above three that is not selected. Among them, the control device is an intelligent device that can be used to control the movable platform to perform related operations, such as a movable terminal device including an intelligent remote control or a smart phone.

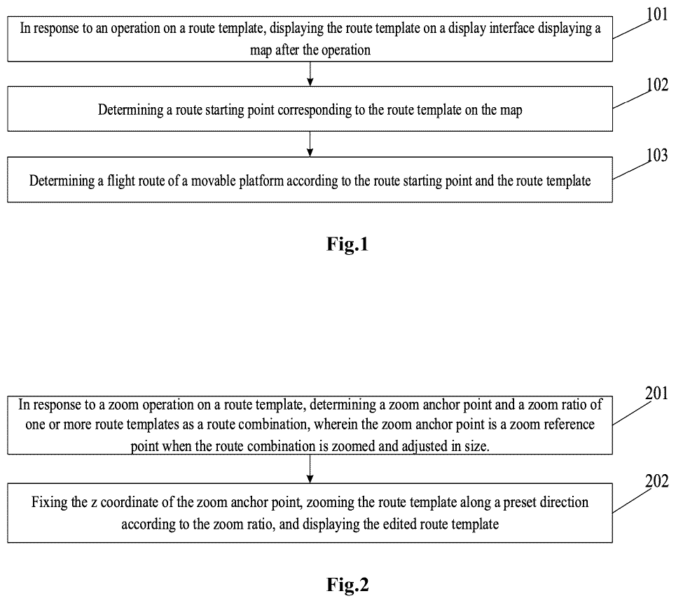

As shown in FIG. 1, in one embodiment, the route generation method includes:

Step 101: in response to an operation on a route template, displaying the route template on a display interface displaying a map after the operation.

The route template may include a route trajectory corresponding to one or more route segments.

In actual application, the movable platform may be a movable device such as an Unmanned Aerial Vehicle (UAV). A communication connection may be established between the control device and the movable platform.

In an actual application, a route template refers to a pre-designed or verified route trajectory (such as a two-dimensional route trajectory or a three-dimensional route trajectory, etc.), and the route template is not bound to specific coordinates. For example, in a UAV route production scenario, the route template is a single segment of a three-dimensional route trajectory suitable for shooting designed or verified by the UAV manufacturer, which is not bound to specific coordinates; this segment of the trajectory comes with the manufacturer's preset editing data for quick shooting.

In an actual application, an operation on the route template may include but are not limited to selection operations and editing operations. Among them, the selection operation can be an operation of selecting a route template from a template library. Exemplarily, an operation mode of the selection operation includes but is not limited to one or more of the following: click, add, drag, or move.

In one embodiment, a selection operation on a route template is detected, and in response to the selection operation, the selected route template is displayed on a display interface displaying a map (such as a two-dimensional map or a three-dimensional map, etc.); the route template includes a route trajectory corresponding to one or more route segments.

In one embodiment, an editing operation on a route template is detected, and in response to the editing operation, the route template is edited, and the edited route template is displayed on the display interface displaying the map (such as a two-dimensional map or a three-dimensional map, etc.); the route template includes a route trajectory corresponding to one or more route segments.

In actual application, the control device may have a display device, which can provide a human-computer interaction interface for the user, display a map on the human-computer interaction interface, display a template library on the human-computer interaction interface, and perform related operations on the human-computer interaction interface.

Step 102: determining a route starting point corresponding to the route template on the map.

In actual application, a route starting point can be a current position of a movable platform or a position specified by a user.

In actual application, the movable platform may be equipped with a positioning device, which may be a satellite positioning device, a GPSmodule, or a visual inertial odometer (VIO), etc., which is not specifically limited in this application. The movable platform may determine its own position through the positioning device.

It should be noted that the present application can first display the selected route template/edited route template on a display interface displaying a map, and then determine the route starting point corresponding to the selected route template on the map; it can also first determine the route starting point and then display the selected route template/edited route template on the display interface displaying the map.

In a feasible scenario, the route starting point may be determined based on a point of interest, where the point of interest is used to indicate a location (eg, coordinates, etc.) or a real object (eg, a building, a landmark, a moving object, etc.) in a real environment.

Step 103: determining a flight route of the movable platform according to the route starting point and the route template.

In actual application, when the route starting point is determined on the map, the selected route template/edited route template can be bound to the map coordinates according to the route starting point to obtain the flight route of the movable platform.

A route generation method provided in an embodiment of the present application includes: in response to an operation on a route template, displaying the route template after the operation on a display interface showing a map; the route template includes a route trajectory corresponding to one or more route segments; determining the route starting point corresponding to the route template on the map; and determining the flight route of the movable platform according to the route starting point and the route template. Through the route generation method provided by one embodiment of the present application, after operating the route template (after selecting the route template and/or editing the route template), the route starting point of the route template is determined on the map, and the route template can be bound to the map coordinates to obtain an executable flight route, thereby realizing rapid generation of the route, and solving the problem of low operating efficiency in the related art of manually generating routes one by one.

In one embodiment, the operation includes: a selection operation and an editing operation. That is, in this embodiment, two types of operations may be performed on the route template. Step 101, that in response to the operation on the route template, displaying the route template after the operation on the display interface displaying the map includes:
in response to a selection operation on the route template, displaying the selected route template on the display interface; and/or
in response to an editing operation on the route template, editing the route template and displaying the edited route template on the display interface.

It can be seen from this that, after selecting a route template, this application supports editing the route template to quickly fine-tune the route template and obtain a personalized and diversified route template.

In one embodiment, the editing operation includes one or more of the following:
a zoom operation configured to adjust flight coverage, a length of the flight trajectory, etc.;
a rotation operation configured to achieve azimuth adjustment, etc.;
a position movement operation configured to achieve template position adjustment, etc.;
a route altitude adjustment operation configured to adjust the highest point and/or the lowest point of the route, etc.; or
a deletion operation configured to delete a single route and reconnect automatically the remaining routes after deletion.

This application can also select desired routes from multiple routes through a check operation, and the checked routes will be automatically reconnected.

In actual application, the editing operation may also include other operations, such as route splicing, etc.

In one embodiment, the number of route templates is one or more, and that in response to the editing operation on the route template, editing the route template and displaying the edited route template includes:

Step 201: in response to a zoom operation on a route template, determining a zoom anchor point and a zoom ratio of one or more route templates as a route combination, wherein the zoom anchor point is a zoom reference point when the route combination is zoomed and adjusted in size.

The xy coordinates of the zoom anchor point are coordinates of a center point of a route segment projected on a xy plane, and the z coordinate of the zoom anchor point is the coordinate of the lowest point in the route trajectory corresponding to the route segment.

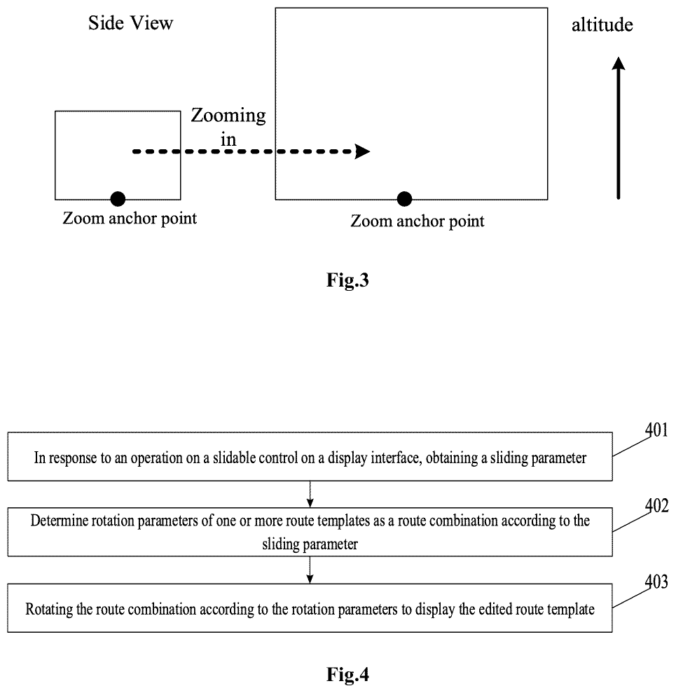

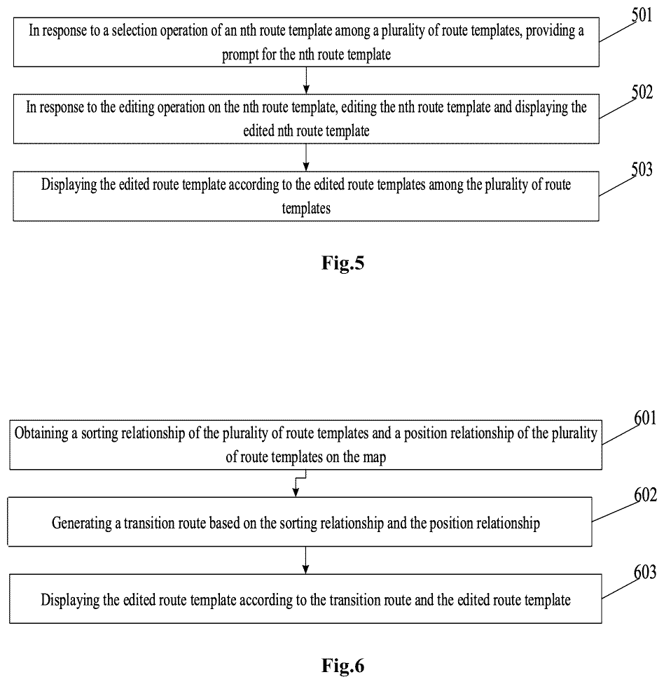

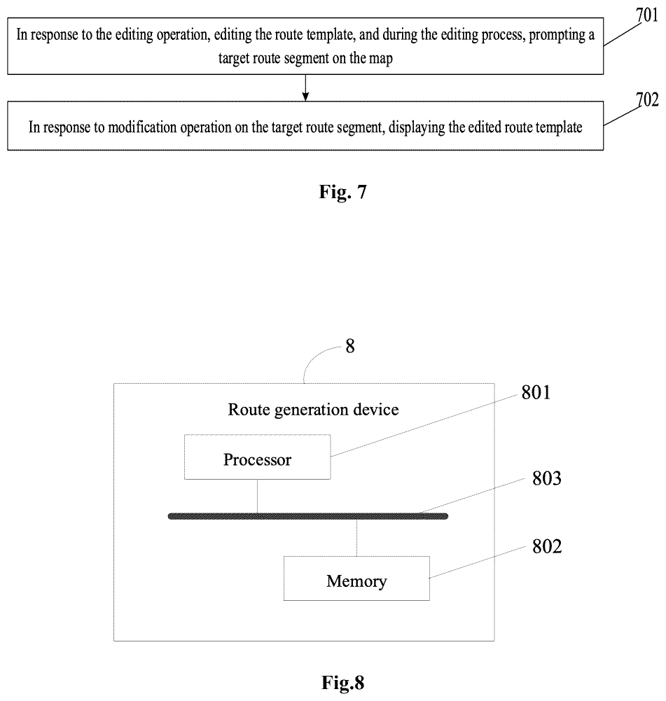

FIG. 3 shows a side view of a user adjusting a zoom ratio (zooming in) when performing a zoom operation, with the route anchor point z at the lowest altitude locked and zooming upward (upward refers to the direction in which the altitude gradually increases in FIG. 3).

Step 202: fixing the z coordinate of the zoom anchor point, zooming the route template along a preset direction according to the zoom ratio, and displaying the edited route template.

The preset direction may include a direction of increasing z-coordinate/decreasing z-coordinate.

In actual application, the zoom ratio can be a default zoom ratio set at the factory, or it can be a zoom ratio matched by different movable platforms, or it can be a zoom ratio after the user fine-tunes the preset zoom ratio according to operation requirements. Exemplary, the zoom ratio range: 0.5˜2 times; the minimum change level: 0.1. From the above, it can be seen that when the present application zooms the route combination (including one or more route templates), the zoom anchor point is used as the zoom reference point of the route combination when zooming and adjusting the size, thereby realizing precise zooming of the route combination.

In actual application, when the number of selected route templates is multiple, the multiple route templates can be used as a route combination. A preset route template combination from the template library refers to a template combination composed of multiple route templates, which is configured to quickly shoot a film; quickly apply finished routes, and set up accurate and mature automatic shooting scripts. Of course, multiple route templates can also be used as a route combination. A template combination is composed of multiple selected route templates. As such, building block template creation provides advanced users with higher degrees of freedom to create and quickly customize personalized routes.

In one embodiment, the number of route templates is one or more, and that in response to the editing operation on the route template, editing the route template and displaying the edited route template includes:

Step 401: in response to an operation on a slidable control on a display interface, obtaining a sliding parameter.

In some embodiments, the slidable control may be a slidable slider icon, a slidable ring icon, etc., and the sliding parameter includes but are not limited to a sliding distance and/or a sliding direction.

Step 402: determine rotation parameters of one or more route templates as a route combination according to the sliding parameter.

In some embodiments, the rotation parameters include but are not limited to a rotation angle, a rotation direction, etc. Among them, the sliding distance determines the rotation angle, and the sliding direction determines the rotation direction.

Step 403 rotating the route template according to the rotation parameters to display the edited route template.

In some embodiments, the route template is rotated according to the rotation parameters, so that the route template combination can be rotated within the range of 0˜360°.

In some embodiments, a mapping relationship between the sliding parameter and the rotation parameter and a rotatable range corresponding to the rotation parameter can be default mapping relationship set by the manufacture or the mapping relationship matched by different movable platforms. The mapping relationship may be one after the user fine-tunes the preset mapping relationship according to the operation requirements, and the rotatable range corresponding to the rotation parameter may be a rotatable range corresponding to the fine-tuned rotation parameter. From the above, it can be seen that when the present application rotates the route combination (including one or more route templates), the sliding parameter obtained by operating the slidable control realizes precise rotation of the route combination.

In one embodiment, the route template includes a plurality of route templates selected in sequence, and that in response to the editing operation on the route template, editing the route template and displaying the edited route template includes:

Step 501: in response to a selection operation of an nth route template among a plurality of route templates, providing a prompt for the nth route template.

Among them, 1≤n≤N, n is a positive integer, N is a total number of the plurality of route templates.

In some embodiments, when the nth route template, i.e., a separate route, is selected (e.g., by checking a box), the nth route template is prompted in the map route preview, such as highlighting the route section and setting parameters for the route section separately.

Step 502: in response to the editing operation on the nth route template, editing the nth route template and displaying the edited nth route template.

Step 503: displaying the edited route template according to the edited route templates among the plurality of route templates.

In some embodiments, the edited route template is a portion or all of the plurality of route templates. That is, in this embodiment, multiple route templates may be selected in sequence to obtain a freely created route combination, and individual route template may be selected for editing, which can be editing a portion of the templates respectively or editing each route template respectively.

In some embodiments, when the nth route template is selected, in response to the editing operation on the nth route template, the nth route template is edited. You can edit only a portion of the route segments, or you can edit all the route segments. This can be done according to actual needs, and this application does not make any specific limitations.

In some embodiments, multiple route templates are selected in sequence to obtain a freely created route combination (including template queue). For the template queue, it has the following features: supporting for viewing selected combinations; supporting for deleting individual route, and automatically reassembling the combination after deletion; supporting for dragging icons in the queue to adjust template sorting; setting upper limit of combinations in the queue: presetting threshold (for example 10); and/or generating template starting point.

In one embodiment, that in response to an editing operation on the nth route template, editing the nth route template, and displaying the edited nth route template includes:

in response to deletion operation of the mth segment of the nth route template, obtaining a plurality of remaining segments of the nth route template, smoothing the plurality of remaining segments, and displaying the edited nth route template; wherein 1≤m≤M, m is a positive integer, and M is the total number of segments included in the nth route template.

In some embodiments, the smoothing the multiple remaining segments can be achieved in the following ways:

Method 1: smoothing is performed based on a height difference and an angle difference between the previous segment and the next segment of the deleted segment whose position is deleted among the multiple remaining segments to obtain the nth route template after smoothing.

Method 2: connecting the end point of the previous segment with the starting point of the next segment of the deleted segment whose position is deleted among the multiple remaining segments to obtain the nth route template after smoothing. In this case, during the execution of the flight segment, fly directly from the end point of the previous flight segment to the starting point of the next flight segment.

In one embodiment, step 503, the displaying the edited route template according to the edited route template among the plurality of route templates includes:

Step 601: obtaining a sorting relationship of the plurality of route templates and a position relationship of the plurality of route templates on the map.

Step 602: generating a transition route based on the sorting relationship and the position relationship.

Among them, the transition route is used to connect different route templates among the plurality of route templates.

Step 603: displaying the edited route template according to the transition route and the edited route template.

In some embodiments, the transition route can be understood as a route segment automatically generated in the middle for connecting and smoothly transitioning two route templates when they are spliced. This application uses a transition route to achieve the connection between multiple route templates, ensures that the connection path between the templates is smooth, and adjusts the spacing and curvature of the connecting segments according to the height difference and the angle difference between the template routes at both ends, so that the connecting effect is consistent with the look and feel. The transition route is an automatically generated route and cannot be adjusted manually.

In one embodiment, step 603, the displaying the edited route template according to the transition route and the edited route template includes:
when the number of edited route templates is less than N, displaying the edited route template based on the edited route templates, the unedited route templates and the transition routes.

In some embodiments, when the number of edited route templates is less than N, it means that some of the plurality of route templates have been edited and some have not been edited. The edited route templates are connected through multiple transition routes to ensure a smooth connection path between the templates.

In one embodiment, step 603, the displaying the edited route template according to the transition route and the edited route template includes:
when the number of edited route templates is N, displaying the edited route template based on the edited route templates and the transition routes.

In some embodiments, when the number of edited route templates is N, it means that the plurality of route templates have all been edited and smoothly transitioned through the plurality of transition routes.

In one embodiment, that in response to the editing operation on the route template, editing the route template and displaying the edited route template includes:

Step 701: in response to the editing operation, editing the route template, and during the editing process, prompting a target route segment on the map.

The target route segment refers to a route segment whose route elevation and a ground elevation associated with the map may meet collision condition.

Step 702: in response to modification operation on the target route segment, displaying the edited route template.

In some embodiments, during route editing, the route elevation and ground elevation are analyzed and compared in real time on a 2D/3D map, and route sections with terrain collision risks are displayed in real time. Route sections with terrain collision risks are prompted on the map, such as highlighting the collision section map trajectory in red to prompt the user to modify the route. Through the collision prompt in route editing, the safety risk of unreasonable route settings can be warned in advance.

In one embodiment, after determining the flight route of the movable platform according to the route starting point and the route template in step 103, the method further includes:
controlling the movable platform to fly according to the flight route; and
displaying execution progress and/or route trajectory of the flight route on the display interface during the flight.

In some embodiments, during the execution of the route, the execution progress and/or route trajectory of the flight route are displayed on the display interface. For example, the entire route trajectory may be previewed in real-time augmented reality (AR) on the head display screen. In this way, the safety of automatic route flight can be expected.

In one embodiment, after controlling the movable platform to fly according to the flight route, the method further includes:
acquiring footages shoot during the flight of the movable platform; and
processing the footages according to editing data associated with the flight route to obtain a target video.

In some embodiments, the processing the footages includes but is not limited to gimbal perspective camera movement and footage speed preset.

The acquired footage includes a panoramic video footage, which may be a panoramic 360° video captured by a panoramic camera. In the process of processing the footage, the application can also freely select at least one desired viewing angle, adjust a desired video image into a view selection frame, and generate a target video.

In the related art, high-altitude routes are usually generated by roughly marking maps, and points of interest can only be set as large landmarks, landscapes, and other fixed coordinates. These routes cannot be accurately aligned with entities and have large restrictions on the shooting subject. Assuming that the route path setting is 100% correct, but the positions of the point of interests in the gimbal camera setting deviate, the final captured footage will also be unusable, and the effect of the point of interests and the pitch angle of the gimbal is not what you see is what you get, which is easy to produce waste films. Furthermore, a user's route path is too long-during the route editing process, the process of setting points of interest, single-point shooting actions, and gimbal pitch angles is lengthy. In this regard, the present application obtains the captured footage by shooting a panoramic 360° video, without limitation of the points of interest (points of interest can be large or small landmarks, landscapes, fixed coordinates, etc.). The desired footage containing points of interest can be obtained by selecting the viewing angle in a later stage.

Among them, gimbal perspective camera movement refers to automatic superposition of a route template segment with preset camera movement data of the UAV manufacturer including perspective movement, segmented editing, and transition special effects. Camera movement includes but not limited to pushing, pulling, shaking, shifting, following, lifting, and throwing, etc., which flexibly controls a displacement of a lens image to inject atmosphere and emotion into the film. Footage speed preset refers to matching a preset speed change effect according to progress of the template route, analyzing curvature change and elevation change of the template route path, and simulating speed change processing of a gravity acceleration effect. This application does not require complex settings such as camera movement and points of interest in the route editing stage, and the footages obtained later have mature editing data that can be directly applied.

In one embodiment, in response to the selection operation of the route template, before displaying the selected route template on the display interface displaying the map, the method further includes:
obtaining user information; and
in a case that the user information meets a first selection condition, providing preset route template combinations for the user to select; or in a case that the user information meets a second selection condition, providing multiple single route templates for the user to select.

In some embodiments, the user information indicates a user level. The user level that meets the first selection condition is lower than the user level that meets the second condition. For users with the lower user level, schemes for quickly applying finished routes are provided, and accurate and mature automatic shooting scripts are set. For users with the higher user level, schemes for building block templates are provided, which provides advanced users with higher degrees of freedom in creation and allows them to quickly customize personalized routes.

The following is an application example to illustrate how to create a flight route using a preset route template combination:

In this scenario, an official preset route template combination is used, directly applied to a user's location, and combination position parameters are fine-tuned to quickly complete the setting. The user only needs to drag the preset route template combination he or she wants to fly on the 2D/3D map and place it on the map and quickly fine-tune the route template parameters, and it can be automatically executed with one click.

In this scenario, route fine-tuning may involve zoom ratio, zoom anchor point, altitude, rotating preset route template combination, and moving a position of preset route template combination.

Exemplarily, the zoom ratio range is 0.5 to 2 times; the minimum change level is 0.1.

Exemplarily, the zoom anchor point: the zoom anchor point is a zoom reference point when the route combination is zoom and adjusted in size; the xy coordinates of the anchor point are a center point of the route projection on a two-dimensional horizontal plane, and the z-direction height of the anchor point is the height of the lowest point in the route trajectory. When the user adjusts the zoom ratio, the z-minimum height of the route anchor point is locked.

Exemplarily, the height is a default preset height, and the user can use a slider to adjust the overall height of the template combination. The highest point and the lowest point of the route cannot exceed the upper limit of 120 m and the lower limit of 10 m respectively.

Exemplarily, when rotating a preset route template combination, a slider may be used to rotate the route template combination within a range of 0 to 360 degrees.

Exemplarily, moving the position of the preset route template combination may be performed by dragging and adjusting the position of the preset route template combination on a two-dimensional/three-dimensional map.

In this scenario, during the execution, an automatic flight progress bar is displayed. The sub-templates are arranged in the order of the route template combination in the progress bar. The length occupied by each sub-template in the progress bar is determined by the corresponding flight time ratio, and the user is informed of the progress of the currently executed sub-template in real time.

The following is an explanation of how to create a flight route freely with application examples:

In this scenario, route templates of various styles are included, allowing the use of a route template library to efficiently create diverse and high-quality route template combinations in a building block manner. A user can freely use single-segment route templates in the template library for free splicing to create a custom route template combination, and support segmented parameter adjustment lines for each segment of the route template to create a personalized and diverse route combination.

In this scene, there is a template library tab: menu-based addition is supported. Clicking the corresponding route to add it to the selected template queue. You can select it repeatedly and the number of repetitions is displayed. Select a template to display a preview of the template sample.

In this scenario, the template queue has the following characteristics:
supporting viewing the selected combination;
supporting deleting individual routes, and automatically reassembling the combination after the deletion;
selecting an individual route and highlighting the route section in the route preview on the map simultaneously, and setting parameters for the route section separately;
dragging icons in the queue to adjust the order of templates;
maximum number of combinations in a queue: 10; and/or
generating a template starting point.

In some embodiments, the generating route starting point includes:
(1) if there is no preceding route or waypoint in the queue, adding a template starting point based on an aerial vehicle's current position.
(2) if there is a preceding route in the queue, keeping a direction of the added route consistent with the previous route. If there is an elevation difference, a transition route will be automatically added.

In one embodiment, when selecting a route template and drag it on the map to change the position of the template, a transition route will be automatically updated.

In one embodiment, route fine-tuning involves adjusting zoom ratio, zoom anchor point, altitude, rotating preset route template combination, and moving route template position.

For example, the zoom ratio range is 0.5 to 2 times; the minimum change level is 0.1

Zoom anchor point: The zoom anchor point is a zoom reference point for the route combination when zooming. The xy coordinates of the anchor point are those of the center point of the route projection on the two-dimensional horizontal plane. The z-direction height of the anchor point is the height of the lowest point in the route trajectory. When the user adjusts the zoom ratio, the z-minimum height of the route anchor point is locked and zoom upward.

For example, each template has a default height, and the user can use the slider to adjust the height of each template individually. The highest and lowest points of the route cannot exceed the upper limit of 120 m and the lower limit of 10 m respectively.

Exemplarily, when rotating a preset route template combination, a slider may be used to rotate the route template combination within a range of 0 to 360 degrees.

Exemplarily, moving the route template position may be accomplished by dragging and adjusting the route template position on a two-dimensional/three-dimensional map.

In some embodiments, the transition route is used to connect multiple route templates. The transition route is used to connect multiple route templates to ensure a smooth connection path between templates. According to the height difference and angle difference between the template routes at both ends, the spacing and curvature of the connection segments may be adjusted to ensure that the connection effect is consistent. The transition route is automatically generated and cannot be adjusted manually.

In the above two scenarios, during the route editing process, the route elevation is compared with the ground elevation in real time on the 2D/3D map, and the route segments with terrain collision risks are displayed in real time. The collision segment map trajectory is highlighted in red to prompt the user to modify the route. The collision detection of the terrain at the location after the route template is generated can avoid shooting obstructions caused by mountainous and urban terrain.

In the above two scenarios, in order to automatically match the preset editing data in the post-editing of the footages shot using the route template, the footages generated by the template route come with preset editing data, which can be used to generate a video with one click in the UAV or on the movable editing software, and output automatically an edited finished video.

In order to implement the route generation method of the embodiment of the present application, one embodiment of the present application also provides a route generation device. In some embodiments, as shown in FIG. 8, the route generation device 800 includes: a processor 801, a memory 802, and a communication bus 803; wherein,
processor 801, configured to execute the method provided by one or more of the above technical solutions when running a computer program;
memory 802, configured to store the computer program that can be run on the processor 801; and
communication bus 803, configured to realize communication connection between the processor 801 and the memory 802.

In one embodiment, the processor 801 is configured to execute a route generation program stored in the memory 802 to implement the following steps:
in response to the operation on the route template, displaying the route template after the operation on the display interface displaying a map; the route template includes a route trajectory corresponding to one or more route segments;
determining a route starting point corresponding to the route template on the map; and
determining a flight route of the movable platform based on the route starting point and the route template.

In some embodiments, the operation includes: a selection operation and an editing operation. That in response to the operation on the route template, displaying the route template after the operation on the display interface displaying the map includes:
in response to the selection operation on the route template, displaying the selected route template on the display interface; and
in response to the editing operation on the route template, editing the route template and displaying the edited route template on the display interface.

In some embodiments, the editing operation includes one or more of the following:
zoom operation;
rotation operation;
position moving operation;
route altitude adjustment operation; and/or
deletion operation.

In some embodiments, the number of route templates is one or more, and the processor 801 is configured to execute the route generation program stored in the memory 802 to implement the following steps:
in response to a zoom operation on a route template, determining a zoom anchor point and a zoom ratio when one or more route templates are used as a route combination; the zoom anchor point is a zoom reference point when the route combination is zoomed and adjusted in size, wherein xy coordinates of the zoom anchor point are coordinates of a center point of the route segment projected on a xy plane, and z coordinate of the zoom anchor point is the coordinate of the lowest point in the route trajectory corresponding to the route segment; and
fixing the z coordinate of the zoom anchor point, zooming the route template along a preset direction according to the zoom ratio, and displaying the edited route template.

In some embodiments, the number of route templates is one or more, and the processor 801 is configured to execute the route generation program stored in the memory 802 to implement the following steps:
in response to an operation on a slidable control on a display interface, obtaining a sliding parameter;
determining a rotation parameter according to the sliding parameter as one or more route templates are used as route combination; and
rotating the route template according to the rotation parameter and displaying the edited route template.

In some embodiments, the number of route templates is one or more, and the processor 801 is configured to execute the route generation program stored in the memory 802 to implement the following steps:
in response to a selection operation of an nth route template among the multiple route templates, providing a prompt for the nth route template; wherein, 1≤n≤N, n is a positive integer, N is the total number of the multiple route templates;
in response to an editing operation on the nth route template, editing the nth route template and displaying the edited nth route template; and
displaying the edited route template based on the edited route template among the plurality of route templates.

In some embodiments, the processor 801 is configured to execute the route generation program stored in the memory 802 to implement the following steps:
in response to a deletion operation of the mth route of the nth route template, obtaining a plurality of remaining routes of the nth route template, smoothing the plurality of remaining routes, and displaying the edited nth route template; wherein, wherein 1≤m≤M, m is a positive integer, M is the total number of routes included in the nth route template.

In some embodiments, the number of route templates is one or more, and the processor 801 is configured to execute the route generation program stored in the memory 802 to implement the following steps:
obtaining a sorting relationship of multiple route templates and their position relationship on the map;
generating transition routes based on the sorting relationship and the position relationship; wherein the transition routes are configured to connect different route templates among the multiple route templates; and
displaying the edited route template based on the transition routes and the edited route templates.

In some embodiments, the number of route templates is one or more, and the processor 801 is configured to execute the route generation program stored in the memory 802 to implement the following steps:
when the number of edited route templates is less than N, displaying the edited route template based on the edited route templates, unedited route templates and transition routes.

In some embodiments, the number of route templates is one or more, and the processor 801 is configured to execute the route generation program stored in the memory 802 to implement the following steps:
when the number of edited route templates is N, displaying the edited route templates based on the edited route templates and the transition routes.

In some embodiments, the number of route templates is one or more, and the processor 801 is configured to execute the route generation program stored in the memory 802 to implement the following steps:
in response to the editing operation, editing the route template, and during the editing process, prompting a target route segment on the map; wherein the target route segment refers to a route segment whose route elevation and a ground elevation associated with the map meet collision condition; and
in response to a modification operation on the target route segment, displaying the edited route template.

In some embodiments, the number of route templates is one or more, and the processor 801 is configured to execute the route generation program stored in the memory 802 to implement the following steps:
controlling the movable platform to fly according to the flight route; and
displaying execution progress and/or route trajectory of the flight route on the display interface during the flight.

In some embodiments, the number of route templates is one or more, and the processor 801 is configured to execute the route generation program stored in the memory 802 to implement the following steps:
acquiring footages shot during the flight of the movable platform; and
processing the footages according to editing data associated with the flight route to obtain a target video.

In some embodiments, the number of route templates is one or more, and the processor 801 is configured to execute the route generation program stored in the memory 802 to implement the following steps:
obtaining user information; and
in a case that the user information meets a first selection condition, providing preset route template combinations for the user to select; or in a case that the user information meets a second selection condition, providing multiple single route templates for the user to select.

It should be noted that the specific operating process of the processor 801 can be understood by referring to the above method, which will not be repeated here.

Of course, in some embodiments, the various components in the route generation device 800 are coupled together through the communication bus 803. It can be understood that the communication bus 803 is used to realize the connection and communication between these components. In addition to the data bus, the communication bus 803 may also include a power bus, a control bus and a status signal bus. However, for the sake of clarity, various buses are marked as communication bus 803 in FIG. 8.

The memory 802 in one embodiment of the present application is configured to store various types of data to support the operation of the route generation device 800. Examples of such data may include: any computer program used to operate on the route generation device 800.

The method disclosed in the above embodiment of the present application can be applied to the processor 801 or implemented by the processor 801 or circuitry. The processor 801 may be an integrated circuit chip with signal processing capabilities. In the implementation process, each step of the above method can be completed by an integrated logic circuit of hardware in the processor 801 or an instruction in the form of software. The processor 801 may be a general-purpose processor, a digital signal processor (DSP), or other programmable logic devices, discrete gates or transistor logic devices, discrete hardware components, etc. The processor 801 can implement or execute the various methods, steps and logic block diagrams disclosed in the embodiments of the present application. The general-purpose processor may be a microprocessor or any conventional processor, etc. In combination with the steps of the method disclosed in the embodiment of the present application, it can be directly embodied as a hardware decoding processor to execute, or it can be executed by a combination of hardware and software modules in the decoding processor. The software module may be located in a storage medium, which is located in the memory 802, and the processor 801 reads the information in the memory 802 and completes the steps of the above method in combination with its hardware.

In an exemplary embodiment, the route generation device 800 can be implemented by one or more application specific integrated circuits (ASIC), DSP, programmable logic device (PLD), complex programmable logic device (CPLD), field programmable gate array (FPGA), general processor, controller, microcontroller unit (MCU), microprocessor, or other electronic components to execute the aforementioned method.

It can be understood that the memory (memory 802) of the embodiment of the present application can be a volatile memory or a non-volatile memory, and can also include both volatile and non-volatile memories. Among them, the non-volatile memory can be a read-only memory (ROM), a programmable read-only memory (PROM), an erasable programmable read-only memory (EPROM), an electrically erasable programmable read-only memory (EEPROM), a magnetic random access memory (FRAM), a flash memory (Flash Memory), a magnetic surface memory, an optical disc, or a compact disc read-only memory (CD-ROM); the magnetic surface memory can be a disk memory or a tape memory. The volatile memory can be a random access memory (RAM), which is used as an external cache. By way of example but not limitation, many forms of RAM are available, such as static random access memory (SRAM), synchronous static random access memory (SSRAM), dynamic random access memory (DRAM), synchronous dynamic random access memory (SDRAM), double data rate synchronous dynamic random access memory (DDRSDRAM), enhanced synchronous dynamic random access memory (ESDRAM), synchronous link dynamic random access memory (SLDRAM), direct RAM bus random access memory (DRRAM). The memory described in the embodiments of the present application is intended to include but is not limited to these and any other suitable types of memory.

In an exemplary embodiment, the present application also provides a storage medium, namely a computer storage medium, specifically a computer-readable storage medium, for example, a memory 802 storing a computer program, and the computer program in the memory 802 can be executed by a processor 801 of a route generation device 800 to complete the steps of the aforementioned method. The computer-readable storage medium can be a memory such as FRAM, ROM, PROM, EPROM, EEPROM, Flash Memory, magnetic surface memory, optical disk, or CD-ROM.

In an exemplary embodiment, the embodiment of the present application further provides a computer program product, including a computer program, which can be executed by the processor 801 of the route generating device 800 to complete the steps of the above method of the above route generating device.

It should be noted that: “first”, “second”, etc. are used to distinguish similar objects, and are not necessarily used to describe a specific order or sequence.

In addition, the technical solutions described in the embodiments of the present application can be combined arbitrarily without conflict.

The above-described embodiments only express several implementation methods of the present application, and the descriptions thereof are relatively specific and detailed, but they cannot be understood as limiting the scope of the present application. It should be pointed out that, for a person of ordinary skill in the art, several variations and improvements can be made without departing from the concept of the present application, and these all belong to the protection scope of the present application. Therefore, the protection scope of the present application shall be subject to the attached claims.

What is claimed is:

1. A route generation device, comprising: at least one processor and at least one memory,
the at least one memory stores a computer program;
the at least one processor, when executing the computer program, is configured to:
in response to an operation on a route template, display the route template on a display interface displaying a map, wherein the route template includes a route trajectory corresponding to one or more route segments;
determine a route starting point corresponding to the route template on the map; and
determine a flight route of a movable platform according to the route starting point and the route template.

2. The route generation device according to claim 1, wherein the operation comprises a selection operation and/or an editing operation, and that in response to the operation on the route template, displaying the route template on the display interface displaying the map after the operation comprises:
in response to the selection operation on the route template, displaying the route template that is selected on the display interface; or
in response to the editing operation on the route template, editing the route template to form an edited route template, and displaying the edited route template on the display interface.

3. The route generation device according to claim 2, wherein the editing operation includes one or more of zoom operation; rotation operation; position moving operation; route altitude adjustment operation; or deletion operation.

4. The route generation device according to claim 2, wherein the route template comprises one or more route templates, and that in response to the editing operation on the route template, editing the route template and displaying the edited route template comprises:
in response to a zoom operation on the route template, determining a zoom anchor point and a zoom ratio of the one or more route templates as a route combination, wherein the zoom anchor point is a zoom reference point when the route combination is zoomed and adjusted in size, xy coordinates of the zoom anchor point are coordinates of a center point of projection of the one or more route segments on a xy plane, and z coordinate of the zoom anchor point is a coordinate of the lowest point in the route trajectory corresponding to the one or more route segments;
fixing the z coordinate of the zoom anchor point;
zooming the route template along a preset direction according to the zoom ratio to obtain the edited route template; and
displaying the edited route template.

5. The route generation device according to claim 2, wherein the route template comprises one or more route templates, and that in response to the editing operation on the route template, editing the route template and displaying the edited route template comprises:
in response to an operation on a slidable control on the display interface, obtaining a sliding parameter;
determining a rotation parameter of the one or more route templates as a route combination according to the sliding parameter;
rotating the route template according to the rotation parameter to obtain the edited route template; and
displaying the edited route template.

6. The route generation device according to claim 2, wherein the route template comprises a plurality of route templates selected in sequence, and that in response to the editing operation on the route template, editing the route template and displaying the edited route template comprises:
in response to a selection operation of an nth route template among the plurality of route templates, prompting the nth route template, wherein 1≤n≤N, nis a positive integer, N is a total number of the plurality of route templates;
in response to the editing operation on the nth route template, editing the nth route template and displaying the edited nth route template; and
displaying the edited route template according to the edited nth route template among the plurality of route templates.

7. The route generation device according to claim 6, wherein that in response to the editing operation on the nth route template, editing the nth route template and displaying the edited nth route template comprises:
in response to a deletion operation of a mth segment of the nth route template, obtaining a plurality of remaining segments of the nth route template, smoothing the plurality of remaining segments to obtain an edited nth route template, and displaying the edited nth route template, wherein 1≤m≤M, m is a positive integer, and M is a total number of segments included in the nth route template.

8. The route generation device according to claim 6, wherein the displaying the edited route template according to the edited nth route template among the plurality of route templates further comprises:
obtaining a sorting relationship of the plurality of route templates and a position relationship of the plurality of route templates on the map;
generating a transition route according to the sorting relationship and the position relationship, wherein the transition route is configured to connect different route templates among the plurality of route templates; and
obtaining the edited route template according to the transition route and the edited nth route template.

9. The route generation device according to claim 8, wherein the obtaining the edited route template according to the transition route and the edited nth route template comprises:
in a case that the number of edited route templates is less than N, obtaining the edited route template according to edited route templates, unedited route templates and the transition route.

10. The route generation device according to claim 8, wherein the obtaining the edited route template according to the transition route and the edited nth route template comprises:
in a case that the number of edited route templates is N, obtaining the edited route template according to the edited route templates and the transition route.

11. The route generation device according to claim 2, wherein that in response to the editing operation on the route template, editing the route template and displaying the edited route template comprises:
in response to the editing operation, editing the route template, and during an editing process, prompting a target route segment on the map, wherein the target route segment refers to a route segment whose route elevation and a ground elevation associated with the map meet a collision condition; and
in response to a modification operation on the target route segment, displaying the edited route template.

12. The route generation device according to claim 1, wherein after determining the flight route of the movable platform according to the route starting point and the route template, the at least one processor is further configured to:
control the movable platform to fly according to the flight route; and
display an execution progress and/or the route trajectory of the flight route on the display interface during the flight.

13. The route generation device according to claim 12, wherein after the controlling the movable platform to fly according to the flight route, the at least one processor is further configured to:
acquire footage shot during flight of the movable platform; and
process the footage according to editing data associated with the flight route to obtain a target video.

14. The route generation device according to claim 2, wherein, in response to the operation on the route template, before displaying the edited route template on the display interface displaying the map, the at least one processor is further configured to:
obtain user information of a user; and
in a case that the user information meets a first selection condition, provide a preset route template combination for the user to select; or in a case that the user information meets a second selection condition, provide a plurality of single route templates for the user to select.

15. A system, comprising:
the route generation device of claim 1; and
the movable platform.

16. The system of claim 15, wherein the route generation device is installed on the movable platform.

17. The system of claim 15, wherein the route generation device is installed on a server or a controller of the movable platform.

18. The system of claim 15, wherein the movable platform is an unmanned aerial vehicle.

19. A route generation method, comprising:
in response to an operation on a route template, displaying the route template on a display interface displaying a map after the operation, the route template including a route trajectory corresponding to one or more route segments;
determining a route starting point corresponding to the route template on the map; and
determining a flight route of a movable platform according to the route starting point and the route template.
